(19) United States
(12) Patent Application Publication
(10) Pub. No.: US 2009/0145314 A1
(43) Pub. Date: Jun. 11, 2009

(54) Intaglio Printing Methods, Apparatuses, and Printed or Coated Materials Made Therewith

(75) Inventor: Alexander BOTRIE, Toronto (CA)

Correspondence Address: BANNER & WITCOFF, LTD., 1100 13th STREET, N.W., SUITE 1200, WASHINGTON, DC, 20005-4051, US

(73) Assignee: CHEMQUE, INC., Rexdale (CA)

(21) Appl. No.: 11/953,006

(22) Filed: Dec. 7, 2007

(51) Int. Cl. B41F 9/00; B41M 1/10

(52) U.S. Cl. 101/153; 101/170

(57) ABSTRACT

Intaglio printing methods and apparatuses are disclosed, involving the use of a curable resin composition (e.g., curable by actinic radiation). The composition may be applied to a substrate, such as a printable material, at a depth of 250 μm or more, in order to create a desirable, three-dimensional effect. To produce this type of printed or coated substrate, the composition is first transferred to cells or recesses, having a depth of these dimensions, onto a printing surface (e.g., a gravure cylinder) and then at least partially cured. The at least partially cured composition is then transferred to the substrate (e.g., paper or plastic) where additional curing may occur, to produce the final printed or coated article.

### FIELD OF THE INVENTION

The present invention relates to intaglio printing methods and apparatuses using resin compositions which cure upon exposure to a particular condition (e.g., actinic radiation, heat, or moisture) and which may be applied to substrates such as printable materials at depths that create a desirable, three-dimensional or doming effect.

### BACKGROUND OF THE INVENTION

In conventional intaglio printing methods, the area of the image to be printed is recessed, using numerous minute recesses, cells, or mold cavities which are engraved into a printing surface, such as a printing plate or a cylindrical gravure surface, and are adapted to be filled with ink. These recesses or cells, which form the image, may be etched or engraved with chemicals or tools. During intaglio printing, the cells are first filled with ink from a reservoir or trough, and excess ink is then wiped (e.g., using a steel doctor blade) from the “non-print” or “land” areas on the plate surface. Pressure is applied to transfer the ink, residing in the volumes of recesses or cells, to a substrate such as paper.

Gravure printing is an example of an intaglio printing method using an engraved printing surface, as described above. In particular, this surface is cylindrical and rotates through the ink reservoir and then past the doctor blade, leaving the recesses or cells full, while excess ink from the land area is returned to the reservoir. The gravure cylinder is normally positioned opposite a soft (e.g., rubber) impression cylinder, in order for an ink image to be effectively transferred or pressed onto a substrate, when fed between the gravure printing cylinder and impression cylinder as both cylinders rotate. Typically, a very high quality image results on the substrate.

Low viscosity, organic solvent-based inks or water-based inks are conventionally used in intaglio printing, such as gravure printing. The drying of these inks normally requires that the substrate to which they are applied be passed through gas or electric fired dryers which can evaporate the organic or aqueous solvent. Additionally, these dryers are generally equipped with pollution control devices to prevent the detrimental solvent constituents from being released into the environment.

Another complicating factor associated with conventional intaglio printing inks is that the cell depth on the printing surface (e.g., gravure cylinder or roller) is constrained to a maximum of about 250 microns (μm). Beyond this depth, the ink cannot be removed from the recesses or cells efficiently, such that often less than about 40% of the ink can be transferred onto the substrate. As a result, the art has attempted to improve the extent of ink transfer from intaglio printing surfaces. For example, U.S. Pat. No. 4,697,514, describes a gravure printing process, where ink transfer to a dielectric surface is improved by electrically charging the ink. This process is now generally referred to as “Electrostatic Assist (ESA).” ESA can provide a maximum ink thickness on a substrate of about 250 μm if the entire ink composition can be electrically charged. However, the ink thickness will generally be lower for inks having organic or aqueous solvent additives.

Doming or lensing resins for coating a wide variety of substrates (e.g., label and decal sheets) are known in the art and are typically clear, colorless, high gloss, thermosetting or UV-curable compositions which, after curing, can provide aesthetic enhancement and/or environmental protection to the substrate (e.g., paper, plastic, metal, glass, wood, etc.). Depending on the particular composition, curing may be achieved by radiation (e.g., in the UV portion of the electromagnetic spectrum), heat (e.g., in the case of thermosetting resins), moisture, or a combination of methods.

Two-component polyurethane doming resin systems are described, for example, in U.S. Pat. No. 4,100,010 and RE 33,175. These compositions are based primarily on aliphatic diisocyanates and are used for most indoor and outdoor applications. Two-component epoxy systems are also employed for doming applications, but are generally less suitable outdoors or otherwise in areas of significant UV light exposure.

Co-pending U.S. Patent Application Publication No. 2006/0251902 describes one-component, moisture curing silylated coating resin compositions that may be used in forming high build coatings. In contrast to two-component systems, these silylated compositions do not require meter-mix-dispensing, produce carbon dioxide bubbles on exposure to moisture, or contain heavy metals.

One-component resin compositions that cure by actinic radiation are conventional in applications where thin coatings are desired (e.g., less than about 100 microns or about 4 mils thick). Co-pending U.S. Patent Application Publication No. 2006/0269756 describes actinic radiation curable doming resin compositions that can be used for providing transparent, high build coatings in doming applications. Also, co-pending U.S. Patent Application Publication No. 2007/0026201 describes the use of actinically cured resins in preparing molded parts.

### SUMMARY OF THE INVENTION

The present invention is associated with the adaptation of intaglio printing methods and apparatuses for use with radiation-, heat-, and/or moisture-curing resin compositions. Advantageously, effecting an at least partial cure of these resins while disposed in the printing surface recesses allows for a very high transfer efficiency of the resin to a substrate, even in the case of recess (e.g., cell) depths of greater than 250 μm. Consequently, modified intaglio printing methods and apparatuses as described herein are suitable for providing printed or coated substrates (e.g., printed paper) having a raised, domed, or three-dimensional printing or coating effect. Whether or not such a raised effect is desired, the resin compositions may be cured on the substrate to provide a wide variety of pictures, patterns, designs, text, etc.

Thus, in the methods and/or the apparatuses described herein, at least partially curing the resin composition while in the recesses of an intaglio printing surface provides for a more efficient release onto a substrate, relative to the efficiency obtained for conventional intaglio printing inks. Subsequently, a complete or more complete cure of the composition, while on the substrate, can provide a printed or coated substrate with a relatively thick printing or coating thereon. The resin composition can thus provide a clear or colored printing or coating. In a particular embodiment, for example, a clear doming resin is used to cover desired portions of a paper substrate (e.g., text that is printed with a conventional ink) to provide an appealing lensing or doming effect.

Aspects of the invention are therefore directed to intaglio printing methods (e.g., gravure printing) where a curable resin composition is transferred into recesses of a printing surface, such as a cylindrical gravure surface. Regardless of the particular type of intaglio printing method, the transfer of the resin composition to the recesses on the intaglio printing surface is often followed by the removal of an excess portion of the resin composition from non-print or land areas on the printing surface. For example, a doctor blade may be used to wipe a cylindrical gravure surface and recycle the excess resin composition to the reservoir for better utilization.

The curable resin composition may be cured, for example, by exposure to radiation, heat, moisture, or by a combination of conditions. Exposure to an appropriate curing condition (e.g., UV radiation), or combination of conditions, at least partially cures the resin composition in the recesses or cells of the printing surface. The at least partially cured resin is then transferred from the recesses onto a substrate. After this transfer, more complete curing by further exposure to the curing condition (or combination of conditions), or even a different curing condition (or combination of conditions), may be desired to obtain a printed or coated substrate. Representative substrates that may be fed to the intaglio printer, and printed on, in this manner include paper and plastic.

A preferred type of curable resin composition is an actinic radiation curable resin (e.g., a resin which cures upon exposure to UV radiation). Advantageously, exposure of actinic radiation curable resin compositions to the appropriate energy, such as UV light, has been found to preferentially cure the “body” of the resin composition when disposed in recesses, such as those normally present on intaglio surfaces. That is, the inner portion of the recess or cell volume that the resin composition occupies, including the portion directly adjacent to the engraved recess or cell surface, cures initially. In contrast, the outer surface of the recess or cell volume does not cure as readily, due to the exposure of this outer portion of resin composition to air.

For example, the curing of actinic radiation curable resin compositions comprising acrylate polymers is chemically inhibited by oxygen. Therefore, the air-exposed outer surface of the actinic radiation curable resin composition can remain tacky even after the body of the resin is more completely or completely cured. Suitable acrylate polymers include epoxy acrylates, urethane acrylates, polyester acrylates, polyether acrylates, amine-modified polyether acrylates, and acrylic acrylates. Acrylate monomers or other reactive monomers having double bond-containing functional groups may be used in conjunction with the acrylate polymers to adjust various characteristics, such as viscosity, exotherm, solvency, surface tension, wetting, adhesion, gloss, heat stability, flexibility, hardness, shrinkage, water resistance, abrasion resistance, glass transition temperature (Tg), and hydrophobicity. There is a wide variety of monofunctional; difunctional, trifunctional and higher functionality acrylate monomers that are commonly used as reactive monomers that may be blended with acrylate polymers. Monofunctional acrylate monomers include, lauryl acrylate, tetrahydrofurfuryl acrylate, phenoxyethyl acrylate, octyl decyl acrylate, caprolactone acrylate, isobornyl acrylate and steryl acrylate. Difunctional acrylate monomers include ethoxylated bisphenol A diacrylate, triethylene glycol diacrylate, dipropylene glycol diacrylate, propoxylated neopentyl glycol diacrylate. Trifunctional acrylate monomers include trimethylolpropane triacrylate, ethoxylated trimethylolpropane triacrylate and pentaerythritol triacrylate. Higher functional acrylates include pentaerythritol tetraacetate and dipentaerythritol pentaacrylate. Methacrylate monomers can also be used. Some examples are tetrahydrofurfuryl methacrylate, ethylene glycol dimethacrylate and trimethylolpropane trimethacrylate. Other reactive monomers in acrylate polymer systems include vinyl ether monomers such as isopropyl vinyl ether, triethyleneglycol divinyl ether and trimethylolpropane trivinyl ether. Actinic radiation curable resin compositions comprising one or more acrylate polymers generally also comprise a free radical polymerization photoinitiator.

Other types of actinic radiation curable resin compositions that are suitable for intaglio printing as discussed herein include those that are cured in the presence of UV cationic curing promoters (or photoinitiators) such as triarylsulfonium hexafluoroantimonate salts. These UV cationic curing compositions or systems comprise an epoxide monomer or polymer (e.g., a cycloaliphatic epoxide, a glycidyl ether, or other epoxide) and/or an oxetane monomer or polymer (e.g., an alkylated oxetane, an alkoxylated oxetane, or other oxetane derivative). These epoxides and oxetanes in UV cationic curing resins may be used in conjunction with one or more property modifiers for property enhancement. Property modifiers in UV cationic curing systems include polyols, unsaturated alcohols, vinyl ether monomers, and epoxidized oils. Epoxide monomers or polymers may also be considered property modifiers in predominantly oxetane UV cationic curing systems and, conversely, oxetane monomers or polymers may be considered property modifiers in predominantly epoxide UV cationic curing systems.

Thiol-ene one-component UV curing systems are also suitable as actinic radiation curable resin compositions. The thiol-ene reaction that is carried out in such systems is characterized by the 1:2 addition of the thiol compound across a double bond of the “ene” or unsaturated (e.g., olefinic) compound. The thiol compound can react with either acrylate or non-acrylate unsaturated monomers and polymers.

Typical thiols used in thiol-ene polymerizations include pentaerythritol tetramercaptopropionate, trimethylolpropane trimercaptopropionate, pentaerythritol tetramercaptoacetate and trimethylolpropane trimercaptoacetate. Some enes, both monomers and polymers, that are typically used in non-acrylate containing thiol-ene polymerizations are norbornenes, allyl ethers, propenyl ethers, allyl triazines, allyl isocyanurates, alkenes, unsaturated esters, maleimides, acrylonitriles, styrenes, dienes and n-vinyl amides. Acrylate, methacrylate and vinyl ether monomers and polymers are also commonly used. Examples of vinyl ether polymers are those supplied in the Vectomer™ product line of Allied Signal (Morristown, N.J., USA). Reactive monomers, which may be different from the ene monomer of the thiol-ene system, can also be blended into thiol-ene systems to reduce viscosity and/or enhance other properties, such as hardness or abrasion resistance, of the cured composition. These reactive monomers include acrylate monomers and other monomers discussed above for use in conjunction with acrylate polymer systems. Free radical polymerization photoinitiators, as discussed herein with respect to acrylate polymer systems, are normally also used in conjunction with thiol-ene systems.

Any of the above actinic radiation curable resin compositions may be clear doming or lensing resins used to cover portions of a paper substrate, which contact the corresponding recesses or cells on the intaglio printing surface. Alternatively, colorizing additives may be included in the resin composition, for example, if visible, raised printed text is desired.

The ability to obtain partially cured resin compositions, having the above-described combination of characteristics within intaglio surface recesses or cells, has important implications for intaglio printing methods. In particular, the tacky exposed outer surfaces of the resin composition-filled recesses or cells provide good adhesion of the composition to the substrate, which contacts these surfaces. In addition, the more completely cured body or inner portion of the resin composition in these recesses facilitates a more complete release of the resin composition from the cells onto the substrate, even at cell depths beyond those considered appropriate for conventional intaglio printing inks. Thus, substrates can be printed or coated, if desired, with a “high build” print or coating using the resin compositions described herein. For example, at least a portion of the intaglio printing surface recesses may have a depth of greater than about 250 μm, or even greater than about 300 μm (e.g., from about 300 μm to about 5 mm, from about 500 μm to about 5 mm, from about 300 μm to about 2 mm, or from about 500 μm to about 2 mm). These depths are thus correspondingly achieved for the cured resin composition, when on the printed or coated substrate.

After the at least partially cured resin composition (e.g., being tacky at its exposed surfaces) is transferred from the recesses or cells to the substrate, further exposure of the resin composition to curing conditions (e.g., exposure to additional actinic radiation) can further cure, or even completely cure, the resin. If the previously uncured, tacky portion (e.g., the exposed surface) of the resin contacts the substrate after the transfer, then this portion is no longer exposed to the air and thus cures readily upon the further exposure to curing conditions.

A preferred method of intaglio printing is gravure printing, in which the intaglio printing surface is a cylindrical gravure surface, as described above. Gravure printing is especially suitable for high speed, high volume printing applications. When used with the curable resin compositions described herein as an alternative to conventional gravure inks, these compositions can effectively flow to fill recesses or cells of up to 5 mm or greater in depth on the engraved printing roller. These compositions are then essentially completely released (i.e., with high efficiency) from the gravure cylinder onto the substrate, with good maintenance of the desired shape (i.e., without significant dispersion) due to the curing characteristics of the resin composition and partial cure of this composition within the recesses or cells, as described above. Thereafter, more complete, essentially complete, or complete curing of the composition on the substrate can provide the desired surface features such as raised, printed text or areas which are otherwise covered with a clear or colored coating. In this manner, at least a portion of the substrate may be printed or coated with the more completely cured or hardened resin composition, having a thickness (e.g., greater than about 300 μm) which can provide a desirable high build or three-dimensional effect.

Other aspects of the invention are directed to printed or coated substrates made using the intaglio printing methods discussed above. Thus, at least a portion of such substrates are printed or coated with a curable resin composition (e.g., an actinic radiation curable resin composition), after having been cured. Also, at least a portion of the resin composition on the substrate can have a depth as described above (e.g., from about 300 μm to about 2 mm).

Other aspects of the invention are directed to modified intaglio printing apparatuses capable of performing the methods discussed above. A representative printing apparatus comprises a printing surface having recesses, such as a gravure cylinder onto which the printing surface is disposed, as well as a reservoir for transferring a curable resin composition, as described above, into the recesses. In the case of a modified gravure printing apparatus, a conventional impression cylinder is generally disposed in a substantially tangential relationship with the gravure cylinder, such that the two cylinders cooperate to support a substrate when fed between the two rotating cylinders. In particular, the impression cylinder, typically made of rubber or other soft material, supports and presses the substrate against the gravure cylinder, in the area where the two cylinders are nearly tangential, causing the resin composition to be released from the gravure cylinder recessions or cells and adhere to the substrate.

As explained above, the partial curing of resin compositions in the recesses of the printing surface allows for the more efficient transfer of the resin composition from these recesses to the substrate. Consequently, significantly deeper recess or cell dimensions are possible in the intaglio printing apparatuses described herein, compared to those which utilize conventional inks. For example, the intaglio printing surface may have at least a portion of recesses or cells with depths in the ranges set forth above.

The apparatus also comprises a source which provides the particular condition, or combination of conditions, used to cure the resin composition. For example, an actinic radiation source, heat source, moisture source, or other type of source may be used to expose the resin composition and/or its surrounding environment to the particular condition or combination of conditions to effect an at least partial cure of the curable resin composition, while it is disposed in the recesses or cells of the intaglio printing surface (e.g., the gravure cylinder). In a preferred embodiment where the resin is an actinic radiation curable resin, for example, the modified intaglio printing apparatus comprises a source of actinic radiation such as UV energy.

The printing apparatus may optionally further comprise an additional source for providing a condition or combination of conditions to further cure the resin composition after it is transferred to the substrate. For example, a source emitting UV radiation may be used with the intaglio printing apparatus to at least partially cure an actinic radiation curable resin composition in the recesses or cells of the intaglio surface, and a second source of actinic radiation (e.g., also UV radiation) may be used to further cure the resin after being transferred to the substrate. The sources may expose the resin to the identical type of conditions (e.g., UV radiation) or the same types of conditions, but at differing intensities, wavelengths, durations, etc. Otherwise, the sources may expose the resin to differing types of conditions, as in the case of a dual cure resin, which may be partially cured by radiation and then further cured upon exposure to moisture or heat.

These and other aspects of the invention are apparent from the following Detailed Description.

### BRIEF DESCRIPTION OF THE DRAWINGS

FIG. 1 illustrates steps of a representative intaglio printing method.

FIG. 2 illustrates representative recesses or cells on a portion of an intaglio printing surface, used to create a text image.

FIG. 3 illustrates a representative modified gravure printing apparatus.

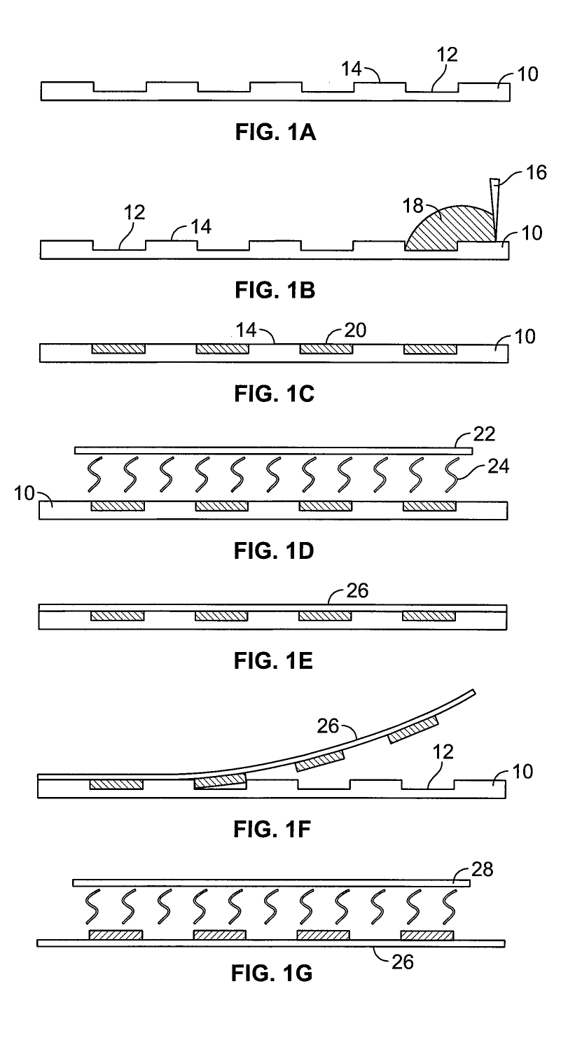

FIGS. 1-3 should be understood as illustrative of various aspects of the invention, relating to the methods and apparatuses described herein and/or the principles involved.

Some features depicted have been enlarged or distorted relative to others, in order to facilitate explanation and understanding. Intaglio printing methods and apparatuses, as disclosed herein, will have processing steps, configurations, components, and operating parameters determined, in part, by the intended application and also the environment in which they are used. FIGS. 1-3 do not limit the scope of the invention as set forth in the appended claims.

### DETAILED DESCRIPTION OF THE INVENTION

Methods according to various aspects of the invention are applicable to intaglio printing, utilizing a printing surface having recesses into which liquid resin is transferred and at least partially cured. Suitable printing surfaces include cylindrical gravure surfaces, plates, belts, sleeves, etc. Anilox surfaces, in which, for example, the entire surface is patterned or etched with an array of closely spaced, shallow cells or depressions, can also be employed. The methods may be used to print over the entire surface of a substrate (i.e., resulting in a coated substrate) or alternatively to print over selected areas of a substrate, in order to produce the same types of printed or coated substrates as produced in conventional doming, coating, printing, lensing, and scripting applications (e.g., using resins or curable inks). Substrates may be printed with pictures, patterns, designs, or text as printed conventionally by intaglio printing methods. These methods, and in particular gravure printing techniques, may therefore be used to apply curable resin compositions, in a precisely defined image, in the high speed, high volume production of coated articles.

Suitable substrates onto which the resin compositions can be printed according to the intaglio printing methods described herein are typically paper and plastic materials. Paper may be pre-printed, for example with conventional ink, such that the resin composition can be printed in a manner to overlap or cover pre-printed text or images. Plastic substrates include polymeric films, foamed materials, and synthetic fabrics. A few of the many synthetic fabrics are polyester, nylon and rayon. Natural fabrics include cotton, wool, and burlap. Metallic substrates such as thin, flexible sheets may also be used. Glass and wood may also be used as substrates. While substrates often have a flat surface, the intaglio printing methods can also be applied to substrates having curved or irregular surfaces, such as the surfaces of bottles, cans, or jars.

Representative substrates therefore include a wide range of printable materials made from paper, plastic, metals, glass, fabrics, or wood, which can be fed to an intaglio printing device and which are generally also suitable for printing with conventional inks. Particular plastic substrates include polybutylene terephthalate (PBT), acrylonitrile-butadiene-styrene (ABS), acrylonitrile-butadiene-styrene blended with polycarbonate (ABS/PC) and other thermoplastic materials known in the art. Other substrates include the “ink-receiving materials,” such as the various cellulose bound materials, described in U.S. Pat. No. 7,141,104, and these ink-receiving materials or substrates are incorporated herein by reference. Suitable transparent substrates are described in U.S. Patent Application Publication No. 2004/091642, and these transparent substrates are incorporated herein by reference.

Intaglio printing is therefore applicable for providing printed or coated articles having the cured resin composition over all or a portion of the substrate, often in a manner to create a high build or three-dimensional effect. Representative printed or coated articles include magazines, catalogues, folding cartons, and flexible packaging made, for example, from paper, film, foil, or wrappers. Also included are printed or coated gift wraps, vinyl, and other plastics, such as those used in wall coverings, curtains, tablecloths, ceiling tiles, floor coverings, and decorative laminates. Other types of printed or coated articles include decals, logos, badges, promotional literature and other promotional items, labels and label sheets, boxes and other packaging materials, nameplates, and signs.

A representative intaglio printing method is depicted in FIG. 1. In particular, part A of FIG. 1 illustrates a section of a simplified intaglio printing surface 10 having both recesses or cells 12 and non-print or land areas 14. A wiper or doctor blade 16 is used to transfer a resin composition 18 as described herein into the recesses 12 of the printing surface 10, as shown in part B of FIG. 1. The wiper or doctor blade 16, or alternatively a separate cleaning or scraping device (not shown), removes an excess portion resin composition 18 from the non-print or land areas 14 of printing surface 10, leaving the recesses 12 filled with the composition 18, having exposed surfaces 20 essentially flush with the land area 14 (i.e., the composition is filled to the depth to which the cells 12 are engraved into the surface 10). The printing surface 10, after transfer of the resin composition 18 into its recesses 12, is shown in part C of FIG. 1.

After the recesses 12 of the printing surface 10 are filled with the resin composition 18, the composition 18 is exposed to a condition such as radiation, heat, or moisture which provides an at least partial cure of the resin composition 18 in the recesses 12. Thus, a source 22 which provides any of these conditions or emissions 24 (e.g., UV light, heat, or moisture) or combination of conditions exposes the resin composition and/or its surrounding environment to the requisite condition(s) to effect an at least partial cure of the curable resin composition 18, while disposed in the recesses or cells 12, as shown in part D of FIG. 1. A preferred type of resin is an actinic radiation curable resin composition, which may be at least partially cured when exposed to actinic radiation from an actinic radiation source (e.g., a UV energy source).

The resulting at least partially cured resin composition is then contacted with a substrate 26 (e.g., paper) to which the composition is transferred, as shown in part E of FIG. 1. In particular, the substrate 26 contacts the exposed surfaces 20 of the at least partially cured resin composition. Often, pressure is applied to the substrate 26 to improve the adherence of the composition to the substrate 26. For example, an impression cylinder in gravure printing is used to push the substrate firmly against the gravure cylinder, when the substrate is fed between the two rotating and substantially tangentially disposed cylinders. Otherwise, the substrate 26 may be simply rolled flat, using a desired amount of rolling pressure, onto the printing surface, having recesses filled with the resin composition.

Advantageously, the cure rate, in the case of some types of resin compositions, is hindered by the presence of air or oxygen. Therefore, an exposed outer surface of an at least partially cured resin composition, in such cases, is cured to a lesser extent than the body or inner portion of the resin composition, residing below the exposed outer surface. This results in beneficial tack and adherence of exposed outer surfaces to the substrate, while at the same time providing excellent release of the body of the resin composition, which is cured to a relatively greater extent than the exposed surface, from the recesses or cells of the intaglio surface. The transfer of the at least partially cured resin composition to the substrate 26 is shown in part F of FIG. 1. As illustrated, the tackiness of the surfaces of the at least partially cured resin composition (which were initially exposed to air and thereafter exposed to the substrate), relative to the (body) portions of the composition within the recesses 12, provides strong adherence of the at least partially cured resin composition to the substrate 26 and a high efficiency of removal of the composition from the recesses 12. In some cases, the resin composition may alternatively be substantially completely or even completely cured within the recesses or cells 12 of the printing surface 10. Regardless of the degree of cure, the transfer of the contents of the recesses or cells 12 onto the substrate 26 may be aided by the use of air or another gas (e.g., nitrogen or nitrogen-enriched air), for example, by supplying the gas at above-atmospheric pressure through one or more small holes (not shown) extending through the printing surface 10 in the areas of the recesses or cells 12.

Often, it will be desired to provide an optional, additional emission source 28 (e.g., radiation, heat, or moisture) as described above to further cure the resin composition after it is transferred to the substrate 26, as shown in part G of FIG. 1. The optional, further curing of the resin will typically promote a more permanent resin/substrate bond and also harden the resin to prevent smearing or spreading. In one representative embodiment, a source emitting UV radiation may be used in intaglio printing for an initial, at least partial, cure of an actinic radiation curable resin composition in the recesses or cells, while a second source of actinic radiation (e.g., also UV radiation) may be used to further cure the resin after being transferred to the substrate. The sources may expose the resin to the identical or differing conditions (e.g., UV radiation at the same or differing intensities, wavelengths, durations, etc.) or identical or differing types of conditions (e.g., partial curing upon exposure to radiation and complete curing upon subsequent exposure to moisture).

As explained above, the use of a curable resin composition provides an efficient release of the at least partially cured resin composition from the recesses or cells of the intaglio printing surface. For example, at least about 40% of the composition (e.g., from about 40% to about 100%, or from about 50% to about 99%) is released onto the substrate, even when the recesses or cells (and consequently the resulting print or coating) have significantly greater depth than that used in conventional intaglio printing. The use of a curable resin composition therefore allows intaglio printing with a high profile, high build, or three-dimensional effect, where the printing (e.g., of pictures, patterns, designs, text, etc.) or the coating, on selected sections of the substrate, can have a depth of greater than about 250 μm. Representative depths, for example, include those in the range from about 300 μm to about 5 mm, from about 500 μm to about 5 mm, from about 300 μm to about 2 mm, and from about 500 μm to about 2 mm. Often, the maximum depth of the printing or coating of cured resin composition on the substrate will be in the range from about 1-2 mm. Intaglio printing methods as described herein are therefore suitable for providing aesthetically pleasing printing effects, for example three-dimensional lettering using opaque, colored resin compositions or even the lensing or doming of text existing on pre-printed substrates, using clear resin compositions.

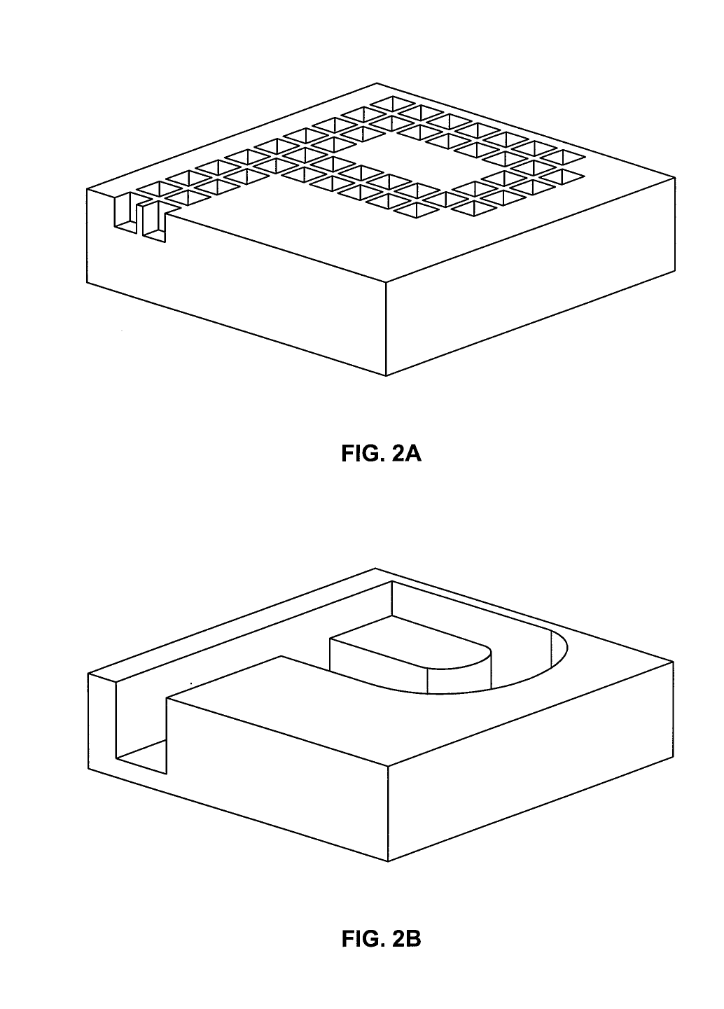

Due to the curing characteristics of the resin compositions described herein, therefore, the depths of the engraved recesses or cells may be increased relative to the depths used in conventional intaglio printing, without a substantial loss in efficiency of the release of the composition to the substrate. Likewise, the breadth of these recesses or cells may also be increased. For example, part A of FIG. 2 illustrates the use of many small intaglio printing surface cells used conventionally to generate a text image. Such small cell dimensions can be used in the printing methods and apparatuses described herein. Alternatively, larger cell sizes can also be used, as a result of the resin curing which takes place while in the recesses or cells, promoting the more complete removal of the composition in a solid or semi-solid form, despite the greater cell dimensions. For example, the plurality of recesses or cells depicted in part A of FIG. 2 can be combined into a single, larger recess or cell, defining a larger unit of text or image, as exemplified in part B of FIG. 2. Recesses or cells on an intaglio printing surface, for purposes of the present invention, therefore also include larger features such as channels and whole letters used to create the printed pictures, patterns, designs, text, etc.

As discussed above, the curable resin compositions described herein may be cured upon exposure to radiation, heat, moisture, etc. or a combination of conditions. An additional advantage associated with many resins of this type over conventional intaglio printing inks is the absence or substantial absence (e.g., less than about 1% by weight) of volatile materials such as aqueous and organic solvents after the resins are completely, substantially completely, or even at least partially, cured on the substrate. The volatiles content is conveniently measured according to art-recognized methods, based on the weight of solids remaining after heating a small (e.g., 1-5 gram), sample of the composition at about 105° C. for about 3 hours. The substantial absence of volatile materials greatly diminishes or even eliminates the need for drying and/or pollution control equipment associated with conventional water- and organic solvent-based inks, after their application to substrates in intaglio printing processes.

Co-pending U.S. Patent Application Publication No. 2006/0251902, describes one-component, moisture curing silylated coating resin compositions that may be used in intaglio printing processes described herein, with the resin compositions being incorporated herein by reference. In contrast to two-component systems, these silylated compositions do not require meter-mix-dispensing, do not produce carbon dioxide bubbles on exposure to moisture, and they do not contain heavy metals.

Of particular interest in the intaglio printing methods described herein are actinic radiation curable resin compositions. Actinic radiation curable resins are those which can be cured or cross linked to form a hardened composition, after exposure to the appropriate energy. This method of resin curing generally proceeds very quickly at room temperature and therefore allows high productivity. Actinic radiation may be in the near infrared, visible, UV, X-ray, or other portions of the electromagnetic spectrum. Also, corpuscular radiation such as an electron beam may be a source of actinic radiation. UV radiation represents a particular type of energy, in the general wavelength range of 4 to 400 nanometers (nm), which can be used to cure a number of doming resin compositions. For example, a medium pressure mercury vapor discharge lamp may be used to supply actinic radiation at wavelength of about 250-400 nm.

Actinic radiation curable resin compositions include those described in co-pending U.S. Patent Application Publication No. 2006/0269756, the resin compositions being incorporated herein by reference. These resin compositions are described as useful for providing transparent, high build coatings in doming applications. They have a viscosity of 50 to 20,000 cps and overcome problems, such as shrinkage and weathering upon outdoor use. The characteristics of such actinic radiation curable resin systems may, however, also be changed or adjusted to accommodate high speed application methods such as gravure printing processes. Suitable changes may include, for example, viscosity adjustment (e.g., viscosity reduction), as described in greater detail below. Advantageously, it has been found that such actinic radiation curable compositions can be appropriately adjusted without compromising the beneficial features (e.g., low shrinkage, good adhesion to the substrate, and other good mechanical properties) of the cured resin and hence the resulting printed or coated substrate.

Suitable actinic radiation curable resin compositions therefore include those comprising acrylate polymers. These acrylate polymer systems are normally inhibited by ambient oxygen in the surrounding air and will therefore advantageously remain tacky, as discussed in detail above, at the surface that is exposed to air, even when the body of the resin within a recess or cell of a printing surface is at least partially cured using actinic radiation.

The cure rate of other types of actinic radiation curable resin systems may not be inhibited or retarded by oxygen to the same degree as in the acrylate polymer systems. In accordance with the methods described herein, the exposed surfaces of resin compositions associated with such resin systems can nevertheless be made to remain tacky. This can be achieved, for example, by decreasing or removing photoinitiators that affect the surface cure, changing the intensity or wavelength of the actinic radiation used, changing the monomers, polymers or additives used in the formulation, or using a combination of these methods. The thiol-ene resin system described above, in which thiol and olefinic moieties react in stoichiometric quantities, is a representative example of an actinic radiation curable resin system that may betailored, in this manner, to a particular application. Thus, the desired tackiness of the exposed surfaces of acrylate polymer systems, as discussed above, can also be readily achieved in intaglio printing methods with a wide range of other types of resin compositions. Those skilled in the art, in view of the present disclosure, can readily adjust the degree to which, for a given actinic radiation curable resin formulation, the surface exposed to air will remain tacky after exposure to UV light. Conversely, the degree of cure of all non air-exposed portions to a tack-free state, after being subjected to UV light, can also be controlled.

Representative acrylate polymers include epoxy acrylates, urethane acrylates, polyester acrylates, polyether acrylates, amine-modified polyether acrylates, acrylic acrylates, and polyol acrylates. One skilled in the art is familiar with the manufacture of these polymers. Aliphatic urethane acrylate polymers in the actinic radiation curable resin compositions provide particularly advantageous properties when cured, including excellent weathering, required for outdoor applications, as well as good flexibility, toughness, and hardness. Examples of actinic radiation curable urethane acrylates, polyester acrylates, epoxy acrylates, and polyol acrylates, as well as the preparation of these polymers, are described in U.S. Patent Application Publication No. 2004/0091642, and these particular polymers are incorporated herein by reference.

Reactive monomers such as acrylate monomers (e.g., lauryl acrylate, 1,6-hexanediol diacrylate, or trimethylolpropane triacrylate) may be incorporated into the actinic radiation curable resin compositions. These reactive monomers can be monofunctional, difunctional, or higher functional, as discussed previously. The addition of acrylate monomers to the resin composition directionally increases the tendency for shrinkage upon curing. Therefore, monofunctional and difunctional acrylate monomers are often incorporated into the doming resin composition when low shrinkage is desired. In some cases, however, shrinkage during cure may be beneficial in intaglio printing applications, for facilitating the removal of the at least partially cured resin from the intaglio cells. In this regard, higher functionality of polyurethane acrylates, polyester acrylates, epoxy acrylates (e.g., aliphatic epoxy acrylates), and acrylic acrylates directionally increase the tendency for shrinkage. Other acrylate monomers are described in U.S. Pat. No. 7,141,104, and these acrylate monomers are incorporated herein by reference. Shrinkage also typically becomes more pronounced as the printing or coating thickness is increased, due to the higher exotherm during curing. In this regard, the amount of monomers used in the resin composition also positively correlates to an increased exotherm and consequently a greater shrinkage tendency.

In addition to acrylate polymers, suitable actinic radiation curing resin compositions also include those containing UV cationic curing polymers. UV cationic curing compositions or systems comprise an epoxide monomer or polymer (e.g., a cycloaliphatic epoxide such as 3,4-epoxycyclohexylmethyl-3,4-epoxycyclohexane carboxylate; a glycidyl ether such as glycidyl ether of bisphenol A; or other epoxide such as limonene dioxide) and/or an oxetane monomer or polymer (e.g., an alkylated or alkoxylated oxetane or other oxetane derivative such as 3-ethyl-3-(hydroxymethyl)oxetane, 3,3-dimethyl-2-(p-methoxy-phenyl)oxetane (MPO) or trimethylolpropane oxetane (TMPO)). These epoxides and oxetanes in UV cationic curing resins may be used in conjunction with one or more property modifiers for property enhancement. Property modifiers in UV cationic curing systems include polyols (e.g., caprolactone polyols such as ε-caprolactone polyols, polyether polyols, or polyester polyols), unsaturated alcohols, vinyl ether monomers, and epoxidized oils (e.g., epoxidized soya and linseed oils). UV cationic curing polymer systems generally exhibit lower volumetric shrinkage than acrylate polymer systems. UV cationic curing systems are also capable of “dark cure,” in which the cationic system continues to cure even after UV exposure, allowing in many cases for increased conversion relative to acrylate systems.

In the case of acrylate polymer-containing resin compositions, a desired viscosity for intaglio printing methods such as gravure printing may be obtained by adjusting the content of acrylate monomers or other reactive monomers (e.g., vinyl ethers) as discussed above, relative to the acrylate oligomer content. By varying these relative amounts, an acceptable tradeoff between viscosity and the extent of shrinkage/brittleness in the cured resin, as discussed above, is established. These relative amounts depend on the particular types of monomers and the particular acrylate resin system being used. Having regard for the present disclosure, the skilled artisan can readily determine the appropriate amounts and types of monomers necessary to achieve a desired viscosity (e.g., a reduced viscosity through monomer addition) without adversely impacting the integrity of the cured coating or doming composition. In the case of non-acrylate based actinic radiation curable doming resins, such as UV cationic cure systems, effective viscosity reduction may also be achieved via the addition of one or more of the property modifiers as discussed above, for use in these systems. In the thiol-ene systems discussed above, viscosity can be modified using one or more reactive monomers as discussed above with respect to the acrylate polymer systems, such as acrylate monomers and/or vinyl ether monomers.

Regardless of the particular type of actinic radiation curing polymer used, an actinic radiation curable resin composition may also incorporate a second type of polymer (e.g., a heat- or moisture- curing polymer) to provide resins which cure to provide high build printing or coating with good tack-free times and low shrinkage. Such polymers are polyurethanes, epoxies, and silylated polymers. Representative silylated polymers are described, for example, in co-pending U.S. Patent Application Publication No. 2006/025190, and these silylated polymers are incorporated by reference. In a representative dual-cure system, therefore, a composition is prepared from an actinic radiation curable resin and a one-component moisture curing silylated polymer. In this dual-cure system, both actinic radiation and moisture are used, as a combination of conditions, to cure the composition. In general, the addition of a non-actinic radiation curing polymer to the resin composition affords a dual-cure characteristic, in which energy from both the actinic radiation, as well as that generated from the reaction of the non-actinic radiation curing polymer, may be used to cure the composition. In such dual-cure systems, the actinic radiation curable monomers and polymers may be present in an amount generally ranging from about 5 wt-% to about 95 wt-%, and typically from about 10 wt-% to about 50 wt-%. Also, the compatibility, in these dual-cure systems, between the polymers, acrylates or other unsaturated moieties can be improved by reacting the acrylate or other suitable monomer, onto the same molecule as the polyurethane, epoxy, or silylated polymer.

The actinic radiation curable resin compositions may further comprise one or more photoinitiators. The photoinitiator can be used alone or in combination with a suitable donor compound or a suitable coinitiator. The photoinitiator and the amount used are selected to achieve a uniform reaction conversion, as a function of the thickness of the coating being cured. The photoinitiator will also determine the degree of total conversion which is based on the desired initial handling strength. The photoinitiator is thus present in an amount sufficient to provide the desired rate of photopolymerization. The amount will depend, in part, on the light source, the thickness of the layer to be exposed to the radiant energy and the extinction coefficient of the photoinitiator at the irradiating wavelength. Generally, the photoinitiator in the actinic radiation curable resin composition will be present in an amount from about 0.01 wt-% to about 10 wt-%, and often from about 0.01 wt-% to about 5 wt-%.

For both acrylate polymer and thiol-ene systems, preferred photoinitiators are capable of initiating free radical polymerization, crosslinking, or both, of the ethylenically unsaturated acrylate moiety on exposure to radiation of a suitable wavelength and intensity. Representative photoinitiators for free radical polymerization include acylphosphine oxides (e.g., acetylphosphine oxides), such as bis(2,4,6-trimethylbenzoyl)-phenylphosphine oxide, bis(2,6-dimethoxybenzoyl)-(2,4,4-trimethylpentyl)phosphine oxide, and 2,4,4-trimethylbenzoyl diphenylphosphine oxide. These types of photoinitiators are typically used in an amount from about 0.03 wt-% to about 0.4 wt-%, and they are often employed for the purpose of “through curing” thick sections of the resin composition. Other photoinitiators include “alpha cleavage type,” compounds, such as benzyl dimethyl ketal, benzoin ethers, hydroxyl alkyl phenyl ketones, benzoyl cyclohexanol, dialkoxy acetophenones, 1-hydroxycyclohexyl phenyl ketone, trimethylbenzoyl phosphine oxides, methyl thio phenyl morpholino ketones and morpholino phenyl amino ketones. The alpha cleavage type photoinitiators are commonly used for surface curing (i.e., reducing surface tack or rendering the surface tack-free). Hydrogen abstracting photoinitiators may also be used. These include a photoinitiator and a coinitiator, based on benzophenones, thioxanthones, benzyls, camphorquinones, and ketocoumarins. Combinations of these photoinitiators may also be employed.

Specific examples of useful commercially available free radical and cationic photoinitiators are described, for example, in co-pending U.S. Patent Application Publication No. 2006/026975, and these photoinitiators are incorporated herein by reference. These photoinitiators are available from manufacturers such as Ciba Specialty Chemicals, Dow Chemicals, and others.

Common photoinitiators used in UV cure cationic systems are mixed triaryl sulfonium hexafluoroantimonate salts, mixed triaryl sulfonium hexafluorophosphate salts and diaryl iodonium hexafluoroantimonate salts. These materials are available from Dow Chemicals. Other photoinitiators are described in U.S. Pat. No. 7,141,104, and these photoinitiators are incorporated herein by reference.

The actinic radiation curable resin composition may also include an effective amount of colorizing additives to provide a color effect to the cured resin. Suitable colorizing additives include, but are not limited to, inorganic pigments such as those based on titanium dioxide, iron oxides, lead oxide, calcium carbonate, cobalt alumina hydrate, barium sulfate, zinc oxide, strontium, chrome, copper, or cobalt. Suitable organic colorants include phthalocyanines, azos, perylenes, quinacridones, indanthrones, and pyrroles. Other colorizing additives, which include dyes and pigments, are described in U.S. Pat. No. 7,141,104, and these colorizing additives are incorporated herein by reference.

Other additives of the doming or coating resin composition include flow agents, viscosity modifiers, foam control agents, plasticizing agents, moisture scavengers, adhesion promoters, temperature stabilizers, and/or ultraviolet radiation stabilizers. Specific examples are provided in co-pending U.S. Patent Application Publication No. 2006/0269756. Other additives include humectants, surfactants, thickeners, antioxidants, solvents, biocides, buffering agents, anti-mold agents, pH adjustment or control agents, electric conductivity adjustment agents, chelating agents, anti-rusting agents, light stabilizers, and conducting or semiconducting polymers, as described in U.S. Pat. No. 7,141,104, and incorporated herein by reference.

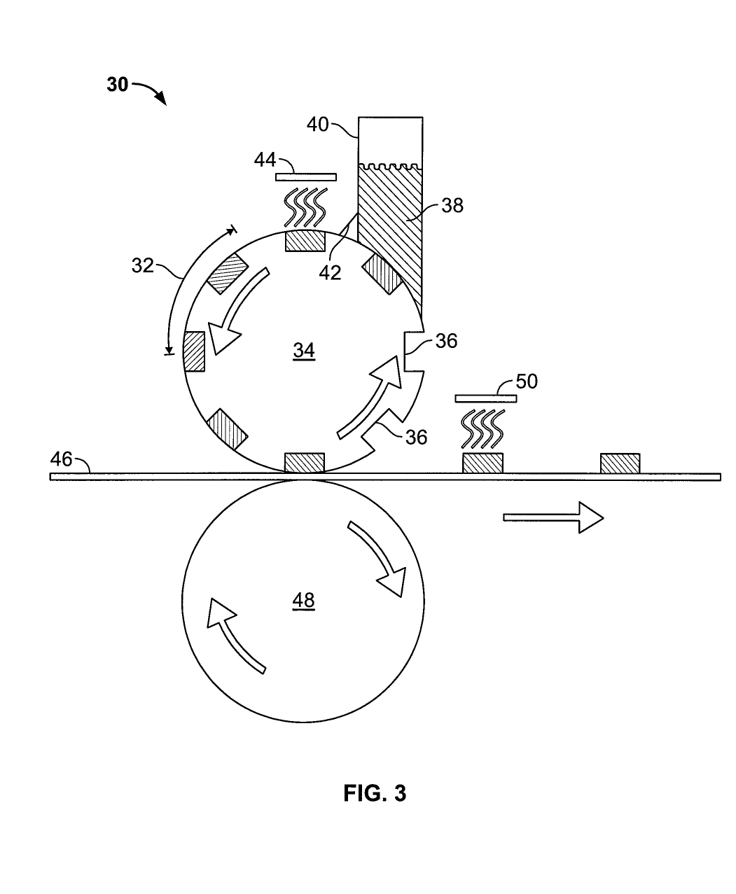

A representative, modified intaglio printing apparatus, and in particular a modified gravure printer 30, is illustrated in FIG. 3. The printing apparatus comprises an intaglio printing surface 32, in this case disposed on a gravure cylinder or roller 34. Other types of intaglio printing surfaces may be used, such as flexible or rigid printing plates. Surfaces can be made of metal, rubber, or plastic, bearing in mind that the surface should be capable of forming a printed text or an image with the desired level of detail and should be capable of efficiently releasing the resin composition, in its partially or fully cured state, onto the substrate. Due to the characteristics of the resin composition, as described herein, and particularly with respect to the ability of the cured resin composition to be easily removed from the recesses, cells, or mold cavities of the intaglio surface, it is also possible to decorate or design the inner surfaces of these recesses, cells, or mold cavities to provide an additional level of structural detail on the printed or coated substrate. A high build resin composition may be cured onto a substrate, for example, with ridges or other types of patterns on one or more surfaces (e.g., its upper surface) to create a desired structure, as dictated by the particular configuration of the mold cavity. The surface of the cured resin composition can therefore, for example, be smooth, textured, or even have a design stamped therein. In this manner, a variety of surface effects, in addition to or together with, a high build or three-dimensional effect as described above, can be achieved.

The printing surface has a plurality of recesses or cells 36 (or engraved mold depressions or cavities), which become filled with a curable liquid resin composition 38, which is generally maintained in a reservoir 40. To obtain a high build or raised printing or coating effect, the recesses or cells 36, or a portion thereof, may have relatively high depths, as discussed above (e.g., in the range from about 300 μm to about 2 mm).

A preferred type of curable resin composition is one which can be cured using actinic radiation such as UV light, although heat- or moisture-curing resin compositions may also be used. In any event, it may be desired to maintain the resin composition in an enclosed environment within the reservoir 40, such that the resin composition is not exposed to ambient light or other ambient conditions which might prematurely cure the liquid composition.

After the liquid, curable resin composition 38 from the reservoir 40 is transferred to, and fills, the recesses or cells 36, excess resin may be removed from the non-print or land areas of the printing surface 32, using a doctor blade 42, wiper, or scraper, typically fabricated of metal, plastic, or rubber. As the gravure cylinder or roller 34 advances or rolls in a counterclockwise direction as illustrated in FIG. 3, the cells or recesses, now filled with a curable resin composition, become exposed to a condition such as radiation, heat, or moisture which provides an at least partial cure of the resin composition 38 in the recesses or cells 36.

Thus, a source 44 provides the requisite condition or emission (e.g., UV light, heat, or moisture) or combination of conditions to effect the at least partial cure (and in some cases a substantially complete or complete cure) of the curable resin composition 38, while disposed in the recesses or cells 36. A representative source 44 is an actinic radiation source, such as a UV energy source (e.g., a UV lamp).

Typically, the resin composition will be formulated, as discussed above, such that the cure rate will be relatively faster for the body (i.e., inner portion) of the resin within the recess or cells, relative to the outer portion exposed to air (i.e., the exposed surface). This difference in cure rate, resulting from the inhibitory effects of oxygen on curing, is therefore exploited in the intaglio printing methods and apparatuses described herein. In particular, while the body of the resin composition exiting the source 44 is hardened due to curing, the exposed surface remains tacky. The combination of a hardened body and tacky surface, in the partially cured resin composition, greatly facilitates both its the release from the recesses or cells 36 of the printing surface 32 as well as its adherence to a substrate 46 onto which the resin composition is printed or coated.

As illustrated in FIG. 3, the substrate 46 is fed between the gravure cylinder or roller 34 and an opposing impression cylinder or roller 48, disposed in a substantially tangential relationship with the gravure cylinder or roller 34. The cylinders 34, 48, by virtue of their proximate tangential relationship, press down upon or grip the substrate 46, advancing it in a left-to-right direction as shown in FIG. 3, when the gravure cylinder 46 and impression cylinder 48, rotate in counterclockwise and clockwise directions, respectively.

As it contacts the substrate 46, the partially cured (or completely cured) resin composition is released from the recesses or cells 36 onto the substrate 46. As illustrated in the embodiment depicted in FIG. 3, an additional source 50 may be used to emit, for example, radiation (e.g., additional UV energy), heat, or moisture, to more completely or completely cure the resin composition after it is printed or coated onto the substrate 46, thereby yielding a printed or coated article having cured resin composition disposed thereon, as described above. In a preferred embodiment, both sources 44, 50 are actinic radiation (e.g., UV light) sources, for example in the form of UV lamps. Further rotation of the gravure cylinder 34 causes additional liquid resin composition 38 to fill the recesses or cells 36, thereby repeating the printing or coating process on other substrates, or another portion of the same substrate.

In other embodiments, the entire amount of resin composition (including the exposed surface) that is deposited into the recesses or cells may be completely or substantially completely cured after exposure to a curing condition emitted from source 44. In such cases, it may even be desirable for the substrate 46 to have a tacky or high tack coating that adheres to the cured resin composition, deposited from the intaglio printing surface 32. This tacky coating may then be cured, for example, using an additional source 50 as discussed herein.

Other embodiments which take account of (1) resin composition curing inhibition due to oxidation, (2) desired mold cavity release properties of cured resin, and/or (3) desired adherence of relatively uncured or tacky resin, will become readily apparent to those having skill in the art, in view of the present disclosure. Exemplary embodiments include curing the surface of the resin composition, while in the recesses or cells 36, into a pressure sensitive adhesive (PSA) that does not require further curing. Thus, additional source 50 is not required, because the composition forms a permanent bond when pressed onto substrate 46. Alternatively, the resin composition may be completely or substantially completely cured while deposited in the recesses or cells 36 using source 44 and the substrate 46 coated or selectively printed in specific areas with a PSA, onto which the completely or substantially completely cured resin composition adheres when released from the recesses or cells 36. Again, additional source 50 is not required. Many additional embodiments, involving at least partially curing the resin composition in the recesses or cells 36, are possible.

In view of the above, it will be seen that several advantages may be achieved and other advantageous results may be obtained. As various changes could be made in the above methods, compositions, and apparatuses without departing from the scope of the present disclosure, it is intended that the disclosure of these methods, compositions, and apparatuses in this application shall be interpreted as illustrative only and not limiting in any way the scope of the appended claims.

The following example is set forth as representative of the present invention. This example is not to be construed as limiting the scope of the invention as other equivalent embodiments will be apparent in view of the present disclosure and appended claims.

### EXAMPLE 1

UV Cationic Curing Resin, Printed onto a Label Using Gravure Printing

UVR-6105, a cycloaliphatic epoxy resin; DER 331, a bisphenol A epoxy resin; and UVI-6976, a mixture of triaryl sulfonium hexafluoroantimonate salts were combined in a ratio of 45.5 parts/45.5 parts/0.05 parts by weight, respectively. All of these resins are commercially available from Dow Chemical. The resulting actinic radiation curable doming resin composition, which was a UV cationic curing resin composition, was a clear, transparent liquid having a viscosity of 2,000 cps at 25° C.

The composition is mixed with a suitable pigment and then applied onto a gravure roller having mold cavities in the formation of a desired image. The pigmented composition is then partially cured using UV light at a predetermined wavelength range, intensity, and duration, such that the resin in the inner mold cavity portions is hardened, while the exposed resin surfaces remain tacky or in a relatively uncured state. By virtue of these characteristics of the partially cured resin, it transfers easily from the roller surface and adheres well on a paper substrate used for labels. The composition remains fixed in a desired three-dimensional coating pattern until being completely cured under a second, high intensity UV lamp. The surface temperature of the composition reaches maximally about 60° C. during the cure.

Following exposure to UV light, the composition continues to cure upon heating for 2 hours at 60° C. Adhesion to the substrate, clarity, gloss, hardness, scratch resistance, and other properties of the cured coating composition are excellent. No curling of the coated article, in this case a flexible label, is observed. The cured coating pattern applied on the label substrate has a thickness of about 2.5 mm.

### EXAMPLE 2

Modification of the Curing Characteristics of Acr late UV Curable Resin Compositions,

UV curable resin System A, System B, and System C, comprising acrylate polymers, acrylate monomers, photoinitiators, etc. were prepared by mixing these constituents in the proportions by weight, as shown in the following Table 1:

TABLE 1
Acrylate UV Curing Systems

| | System A | System B | System C | Type |
|---|---|---|---|---|
| Urethane Acrylate Polymer, | 65.0 | 65.0 | 65.0 | Acrylate Polymer |
| ER-05002-82 | | | | |
| Lauryl Acrylate Monoacrylate | 16.2 | 16.2 | 16.2 | Monofunctional |
| | | | | Acrylate Monomer |
| 1,6-Hexanediol Diacrylate | 15.6 | 15.6 | 15.6 | Difunctional |
| Monomer | | | | Acrylate Monomer |
| Irgacure 184 Photoinitiator | 1.8 | 1 | 2.3 | Surface Cure |
| Irgacure 819 Photoinitiator | — | — | 0.15 | Through Cure |
| Tinuvin 328 | — | — | 0.5 | UV Light Stabilizer |
| Tinuvin 765 Stabilizer | — | — | 0.5 | Hindered Amine |
| | | | | Light |

A 2.0 mm high dome of the UV curable acrylate resin composition, System A, was cured under a high intensity mercury “D” lamp at conveyor speed of 20 ft/min, and the air-exposed surface of the composition fully cured to a tack-free state.

System B was another UV curable acrylate resin composition, but containing a smaller amount of Irgacure 184 photoinitiator than present in System A. Under the same curing conditions as used for System A, the air-exposed surface of the composition remained tacky.

System C was a third type of UV curable acrylate resin composition, having the same relative amounts of acrylate polymers and monomers as in Systems A and B. System C, however, contained UV stabilizers to improve outdoor weathering properties, as well as higher amounts (relative to both systems A and B) of the surface cure photoinitiator (Irgacure 184) and the through cure photoinitiator (Irgacure 819). Upon curing System C under the same conditions as used for Systems A and B, the body of the composition was completely cured while the surface remained slightly tacky.

The above results demonstrate the ability to vary the content of photoinitiator and/or stabilizers, in order to obtain desired curing characteristics (e.g., a higher or lower degree of cure of the air-exposed surface).

### EXAMPLE 3

### Modification of the Characteristics of Thiol-ene UV Curable Resin Compositions,

UV curable resin System E and System F, comprising the thiol compound pentaerythritol tetramercaptopropionate, acrylate polymers and monomers, etc. were prepared by mixing these constituents in the proportions by weight, as shown in the following Table 2:

TABLE 2
Thiol-ene UV Curing Systems

| | System D | System E | Type |
|---|---|---|---|
| Urethane Acrylate Polymer, | 63.8 | 63.8 | Acrylate Polymer |
| ER-05002-155 | | | |
| Triethylene Glycol Divinyl | 12.8 | 12.8 | Difunctional |
| Ether Monomer | | | Vinyl Ether |
| Triphenyl Phosphite | 1.0 | 1.0 | Stabilizer |
| Micronized Red Pigment | — | 0.4 | Red Pigment |
| Irgacure 184 Photoinitiator | 1.0 | 1.4 | Surface Cure |
| Irgacure 819 Photoinitiator | — | 0.25 | Through Cure |
| Pentaerythritol | 20.2 | 20.2 | Thiol |
| Tetramercaptopropionate | | | |

Both of the UV curable thiol-ene resin compositions, Systems D and E above, were completely through cured (i.e., had cured bodies) after exposure to a high intensity mercury “D” lamp at a conveyor speed of 20 ft/min, while the air-exposed surfaces of these compositions were tacky.

System D produced a clear, transparent cured resin and System E produced and opaque red composition.

The above results demonstrate the ability of both clear and decoratively colored thiol-ene UV curable resin compositions to be preferentially cured in the body of the composition, while retaining desired tackiness of air-exposed surfaces of the composition.

What is claimed is:

1. A method of intaglio printing, the method comprising:
(a) transferring an actinic radiation curable resin composition into recesses on a printing surface,
(b) exposing the resin composition to actinic radiation to provide an at least partially cured resin composition in the recesses, and
(c) transferring the at least partially cured resin composition from the recesses to a substrate.

2. The method of claim 1, wherein the printing surface is a cylindrical gravure surface.

3. The method of claim 1, further comprising, after step (a), removing an excess portion of the resin composition from non-print areas on the printing surface.

4. The method of claim 1, further comprising, after step (c), exposing the at least partially cured resin composition to additional actinic radiation to further cure the at least partially cured resin composition.

5. The method of claim 1, wherein the actinic radiation curable resin composition is a thiol-ene system comprising a thiol compound and an unsaturated monomer or polymer.

6. The method of claim 5, wherein the thiol-ene system comprises a reactive monomer that is different from the unsaturated monomer.

7. The method of claim 1, wherein the actinic radiation curable resin composition comprises an acrylate polymer.

8. The method of claim 7, wherein the acrylate polymer is selected from the group consisting of an epoxy acrylate, a urethane acrylate, a polyester acrylate, a polyether acrylate, an amine-modified polyether acrylate, and an acrylic acrylate.

9. The method of claim 7, wherein the actinic radiation curable resin composition further comprises a free radical polymerization photoinitiator.

10. The method of claim 1, wherein the actinic radiation curable resin composition is a UV cationic curing composition comprising an epoxide monomer or polymer or an oxetane monomer or polymer.

11. The method of claim 10, wherein the UV cationic curing resin composition further comprises a property modifier.

12. The method of claim 10, wherein the UV cationic curing resin composition further comprises a UV cationic curing photoinitiator.

13. The method of claim 1, wherein at least a portion of the recesses have a depth of greater than about 300 μm.

14. The method of claim 1, wherein the substrate comprises paper or plastic.

15. A printed or coated substrate made according to the method of claim 1.

16. The printed or coated substrate of claim 15, wherein
at least a portion of the substrate is printed or coated with the actinic radiation curable resin composition, after having been cured,
wherein at least a portion of the resin composition has a depth from about 300 μm to about 2 mm.

17. A modified intaglio printing apparatus comprising:
(a) a printing surface having recesses,
(b) a reservoir for transferring an actinic radiation curable resin composition into the recesses, and
(c) a source of actinic radiation for at least partially curing actinic radiation curable resin composition in the recesses.

18. The printing apparatus of claim 17, further comprising a gravure cylinder onto which the printing surface is disposed.

19. The printing apparatus of claim 18, further comprising an impression cylinder disposed in a substantially tangential relationship with the gravure cylinder for supporting a substrate passing between the gravure cylinder and the impression cylinder.

20. The printing apparatus of claim 17, wherein at least a portion of the recesses have a depth from about 300 μm to about 2 mm.

21. The printing apparatus of claim 17, further comprising an additional source of actinic radiation for further curing the curable resin composition on a substrate.

22. The printing apparatus of claim 21, wherein the source of actinic radiation and the additional source of actinic radiation emit UV radiation.
